(19) United States
(12) Patent Application Publication
(10) Pub. No.: US 2007/0092098 A1
(43) Pub. Date: Apr. 26, 2007

(54) Headphones with elastic earpiece interface

(76) Inventor: Johann Kaderavek, Vienna (AT)

Correspondence Address: BRINKS HOFER GILSON & LIONE, P.O. BOX 10395, CHICAGO, IL, 60610, US

(21) Appl. No.: 11/583,992

(22) Filed: Oct. 19, 2006

(30) Foreign Application Priority Data
Oct. 21, 2005 (EP) 05450176.2

(51) Int. Cl. H04R 25/00

(52) U.S. Cl. 381/370; 381/371

(57) ABSTRACT

An improved headphone design delivers an improved listening experience. The headphones provide comfortable and uniform earpiece pressure against the listener's ear. The headphones help eliminate environmental noise and reduce audible interference, masking, and other undesirable intrusions into the listening experience.

### BACKGROUND OF THE INVENTION

1. Priority Claim

This application claims the benefit of priority from European Patent Application No. 05450176.2, filed Oct. 21, 2005, which is incorporated by reference.

2. Technical Field

The application relates to headphones, and in particular, to the interface between the headband and the earpiece.

3. Related Art

The proliferation of portable music devices and similar products has led to an increased use of headphones for private listening purposes. Headphones and their earpieces may be configured in a variety of ways to adapt to different head shapes and sizes as well as different ear shapes and sizes. Some headphone earpiece types include circumaural, an earpiece type that completely surrounds the ear; supra-aural, an earpiece type that rests on top of the ear; earbuds, an earpiece type that sits in the ear canal opening; and canalphones, an earpiece type that sits inside the ear canal.

Sound clarity is important regardless of headphone design. One way in which headphones provide clarity is to isolate listeners from the environment so that the audio is not overwhelmed, masked, or corrupted by noise. In addition, the headphones may incorporate noise suppression circuitry and other signal processing techniques to enhance clarity. However, the processing circuitry can be expensive, cumbersome, and prone to malfunction.

Another way to isolate a listener from environmental noises is to improve the interface between the listener's ear and the earpiece. Some headphones use elastic headbands to form the headphones to a listener's head, but the elastic headbands do not consistently create a uniform seal of the earpiece against the listener's ear. Other headphones have adjustable earpieces that move in one dimension, but such headphones typically use non-durable materials that apply uneven pressure to the earpiece. In other designs, the headphones allow the earpiece to slide longitudinally along the headband, but only allow for adjustment for the listener's ear position rather than improving environmental isolation. In other words, prior headphone designs were often mechanically complicated and therefore subject to jamming and mechanical failure, and also permitted significant environmental noise to interfere with the audio program. Other technologies try to address mechanical effects on sound quality. In some loudspeaker designs, for example, a labyrinth-like pattern of bars acts as a set of leaf springs and connect the loudspeaker cover with the housing. The bars are intended to uncouple oscillations and vibrations between the cover and the housing, but are not designed to form any kind of seal against a listener's ear.

Therefore, there exists a need for headphones that improve the interface between the listener's ear and the earpiece.

### SUMMARY

A headphone earpiece design gives an improved listening experience. The headphones provide a comfortable and uniform earpiece seal on the listener's ear. Thus, the headphones assist in eliminating environmental noise and reducing unwanted interference in a listener's audio program.

The headphones include a headband and one or more earpieces. Each earpiece may include an electroacoustic converter to translate an audio input signal to sound. An elastic interface may connect the earpiece to the headband. The elastic interface biases the earpiece against the listener's ear. In particular, the elastic interface provides a force on the earpiece to seal the earpiece against the ear. The elastic interface may be selected to provide a uniform, comfortable, and/or constant pressure on the ear to create the seal. The elastic interface may be made from an electrically conductive material. The electrically conductive elastic interface may couple audio input signals through the elastic interface to the electroacoustic converters.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 shows headphones with a headband and earpieces.

FIG. 2 shows an electroacoustic converter attached to an earpiece attachment structure through a flat spring.

FIG. 3 shows a flat spring.

FIG. 4 shows an earpiece attached to an earpiece attachment structure through a flat spring.

FIG. 5 shows a headset with a headband, earpieces, and a microphone.

FIG. 6 shows a square flat spring.

FIG. 7 shows a circular flat spring.

FIG. 8 shows an oval flat spring.

FIG. 9 shows an octagonal flat spring.

FIG. 10 shows a rectangular flat spring.

FIG. 11 shows a circular flat spring.

FIG. 12 shows a triangular flat spring.

FIG. 13 shows a multiple piece circular flat spring.

FIG. 14 shows a cross section of an electroacoustic converter and a multiple layer flat spring.

FIG. 15 shows a flat spring.

FIG. 16 shows a flat spring.

FIG. 17 shows an electroacoustic converter attached to an earpiece attachment structure through a flat spring.

FIG. 18 shows an electroacoustic converter attached to an earpiece attachment structure through an elastic layer.

FIG. 19 shows a process to manufacture headphones.

### DETAILED DESCRIPTION OF THE PREFERRED EMBODIMENTS

Headphones may reduce outside noise by applying a constant, uniform, and comfortable pressure on the earpieces against the listener's ears. The headphones provide a better seal for the earpiece against the outside environment and provide an improved listening experience. An elastic interface may apply the pressure. The elastic interface may be conductive, and may assist with connecting an audio input signal to electroacoustic converters. When multiple earpieces are present, each may be independently adjustable on the headband.

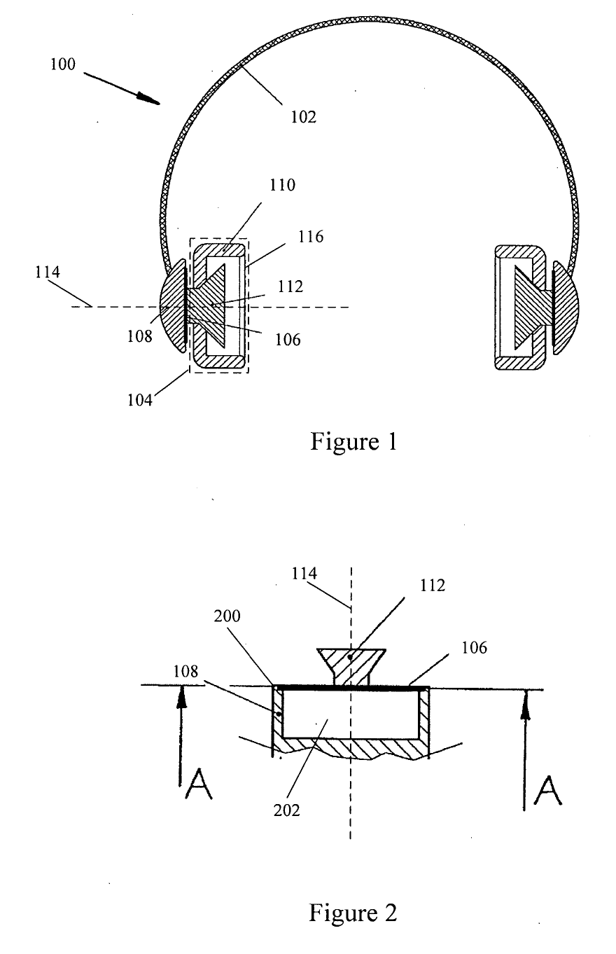

FIG. 1 shows headphones 100. The headphones 100 include a headband 102, one or more earpiece units (e.g., the earpiece unit 104), elastic interfaces (e.g., the flat spring 106), and earpiece attachment structures (e.g., the earpiece attachment structure 108). The earpiece unit 104 may include earpieces (e.g., the earpiece 110), electroacoustic converters (e.g., the electroacoustic converter 112), and/or other structure or electronics. The headband 102 helps keep the headphones 100 in place on the head. FIG. 1 shows the headband 102 in an over the head position. The headphones 100 may alternatively employ a behind-the-neck band, a behind-the-head band, an under-the-chin band, or some other earpiece unit retention structure.

The flat spring 106 may be a substantially planar resilient object. The flat spring 106 may store energy when deflected by an external load and return a force in a direction substantially perpendicular to the spring surface. The force that the flat spring 106 applies helps the earpiece 110 establish a comfortable, uniform, and/or consistent pressure against the ear.

The flat spring 106, although substantially planar, may be arched or curved and thus may be formed in a planar shape (e.g., a disk), curved shape, arched shape, or other shape that extends beyond the major plane of the flat spring 106. The flat spring 106 may also be implemented with, or include, band springs, spiral springs, plate springs, lamellar springs, or other springs. The resilient and elastic properties of the flat spring 106 may be chosen and tailored by designing recesses and cutouts in the spring, and/or by adapting the number and types of spring elements, spring and element shapes, and/or spring and element sizes. The shape of the flat spring 106 may be circular, oval, elliptical, rectangular, or any other shape. The flat spring 106 may be manufactured from resilient steel, elastic plastic, spring bronze, rubber, resilient flexprint, or other elastic materials.

The flat spring 106 may sit inside the earpiece attachment structure 108. Each earpiece attachment structure 108 may be attached to a portion (e.g., an end) of the headband 102. FIG. 1 shows a dish-shaped example of an earpiece attachment structure 108 at the end of the headband 102. The headset 100 may include other structures with other shapes that connect to the elastic interface. The flat spring 106 may serve as an attachment point for the electroacoustic converter 112 or earpiece 110. As shown in FIG. 1, the earpiece 110 attaches to and substantially surrounds the electroacoustic converter 112, though other earpiece shapes and designs may be implemented.

The flat spring 106 and the earpiece 110 may be positioned substantially parallel to one another. The flat spring 106 may apply a constant and uniform pressure on the electroacoustic converter 112 and the attached earpiece 110. The pressure is exerted along an axis 114 perpendicular to and away from the flat spring 106. The inner surface 116 of the earpiece 110 may rest on or around a listener's ear so that the listener can hear the sound produced by the electroacoustic converter 112. The inner surface 116 of the earpiece 110 thus applies a constant and uniform pressure on the listener's ear, creating a seal against the outside environment.

The earpiece 110 may be a circumaural earpiece that completely surrounds the ear. Alternatively, the earpiece 110 may be a supra-aural earpiece that rests on top of the ear. The earpiece 110 may be an open-back earpiece, in which the back of the earpiece 110 is open to the air and acoustically transparent. The earpiece 110 may also be a closed-back earpiece, in which the back of the earpiece 110 is sealed against the outside environment.

The electroacoustic converter 112 may translate the signal from an audio input source into sound waves. The converter 112 may be a dynamic converter, isodynamic converter, electrostatic converter, electret converter, or other type of converter.

FIG. 2 shows a cross section of the electroacoustic converter 112 attached to the earpiece attachment structure 108 through the flat spring 106, omitting the earpiece 110. The flat spring 106 may exert a pressure along the axis 114 perpendicular to and away from the flat spring 106. FIG. 2 shows that the outer edge of the flat spring 106 sits in a notch 200 and that the flat spring 106 sits in a recess 202 in the earpiece attachment structure 108.

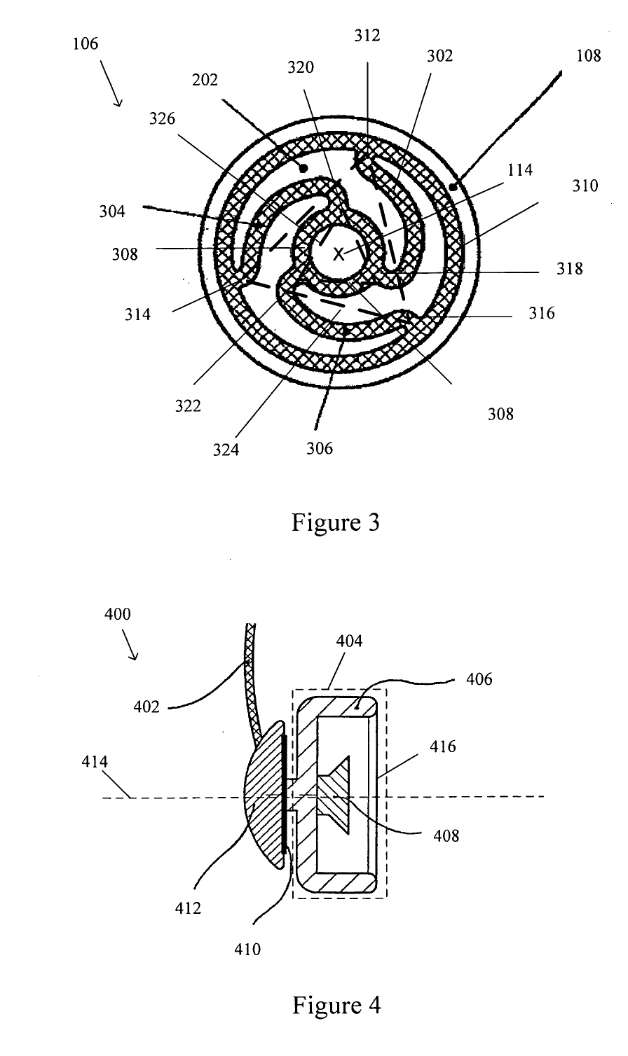

FIG. 3 shows a view of the flat spring 106 taken along line A—A of FIG. 2. The flat spring 106 is depicted along the axis 114 perpendicular to the flat spring 106. The recess 202 permits movement of the flat spring 106 along the axis 114. The flat spring may include an inner connector (e.g., an inner ring) and an outer boundary (e.g., an outer ring). In the example shown in FIG. 3, three spiral-shaped arms 302, 304, and 306 radially extend from the center ring 308 to the outer circumferential boundary 310. The converter 112 may attach to the center ring 308 of the flat spring 106.

FIG. 3 shows three arms 302, 304, and 306, but the flat spring 106 may include any number of arms. The outer connection points 312, 314, and 316 of the arms 302, 304, and 306 on the outer circumferential boundary 310 may be arranged at regular or irregular intervals. The inner connection points 318, 320, and 322 of the arms 302, 304, and 306 on the center ring 308 may also be arranged at regular or irregular intervals. For example, the regular intervals may be the apexes of an equilateral polygon. In FIG. 3, the outer connection points 312, 314, and 316 form an equilateral triangle 324 and the inner connection points 318, 320, and 322 form an equilateral triangle 326. One benefit of choosing connection points as equilateral polygon apexes is that a particularly homogeneous application pressure results. In other words, the connection points give rise to a uniform and/or constant pressure of the earpiece 110 against the ear when the headphones are worn.

The flat spring 106 need not have an outer circumferential boundary 310 for the arms 302, 304, and 306 to attach to. Instead, the outer connection points 312, 314, and 316 may be directly attached to the earpiece attachment structure 108 or other structure. Similarly, the flat spring 106 need not have a center ring 308 for the arms 302, 304, and 306 to attach to. The inner connection points 318, 320, and 322 may be directly attached to the earpiece unit 104 of FIG. 1.

The arms 302, 304, and 306 may include multiple pieces. For example, each arm 302, 304, and 306 may include smaller springs. Similarly, the center ring 308 and outer circumferential boundary 310 may also include multiple pieces.

FIG. 4 shows a portion of headphones 400 with an alternate configuration of the earpiece unit 404, and focuses on one end of the headband 402. In this configuration, the earpiece 406 attaches to the flat spring 410, and substantially surrounds the converter 408. The earpiece 406, the converter 408, and/or other structures or circuitry may be included in the earpiece unit 404.

The flat spring 410 and the earpiece 406 may be positioned substantially parallel to one another. The flat spring 410 may apply a constant, uniform, and/or comfortable pressure on the earpiece 406 and the attached converter 408. The pressure is exerted on an axis 414 perpendicular to and away from the flat spring 410. The inner surface 416 of the earpiece 406 may rest on or around a listener's ear. The inner surface 416 of the earpiece 406 thus applies a constant and uniform pressure on the listener's ear, creating a seal against the outside environment.

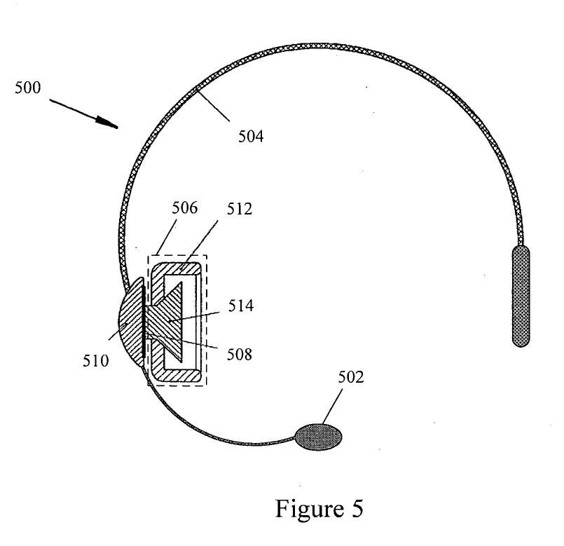

FIG. 5 shows a headset 500 that includes a microphone 502. The microphone 502 may add two-way communication capability to the headset 500. The headset 500 may include a headband 504, earpiece unit 506, flat spring 508, and earpiece attachment structure 510. The earpiece unit 506 may include an earpiece 512 and electroacoustic converter 514. As shown in FIG. 5, the earpiece 512 attaches to and substantially surrounds the electroacoustic converter 514, though other shapes and designs may be implemented. The microphone 502 may be an acoustic-to-electric converter that translates sound waves into a signal. The microphone 502 may be a condenser microphone, an electret condenser microphone, dynamic microphone, ribbon microphone, carbon microphone, piezo microphone, or other type of microphone.

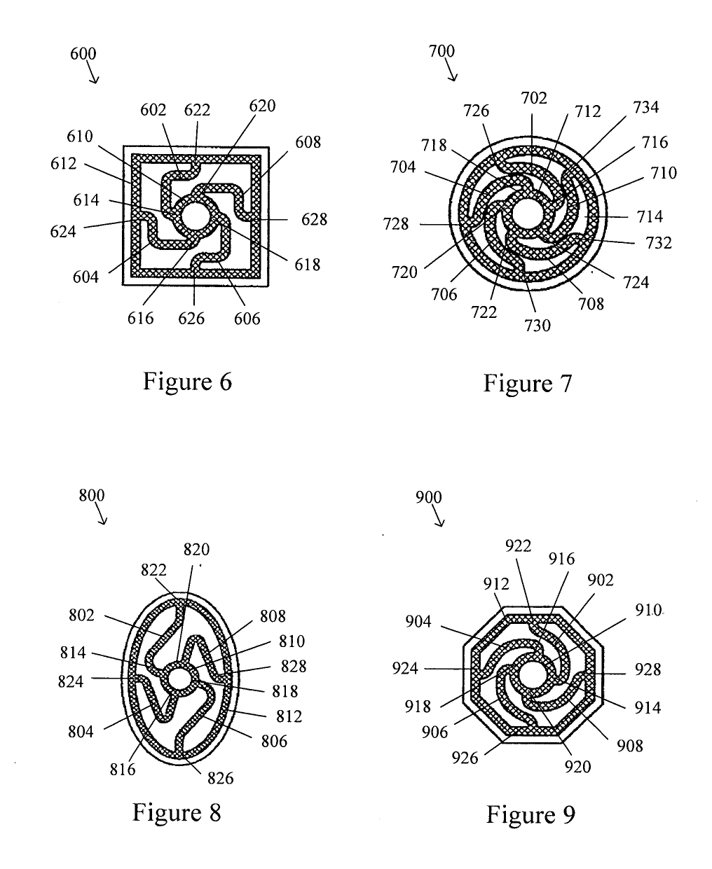

FIGS. 6 through 12 show examples of alternative flat springs that vary in shape, size, and arm configuration. The shape, size, and arm configuration of a flat spring may be adapted to any particular headphone design, earpiece design, or converter design. In the examples shown below, the inner and outer connections points are arranged on the apexes of equilateral polygons, though other designs may also be implemented.

FIG. 6 shows a square flat spring 600 with four arms 602, 604, 606, and 608. The flat spring 600 has an inner ring 610 and square outer boundary 612. The inner connection points 614, 616, 618, and 620 are located approximately every 90 degrees along the inner ring 610. The outer connection points 622, 624, 626, and 628 are located approximately at the center of each side of the square outer boundary 612.

FIG. 7 shows a circular flat spring 700 with five spiral-shaped arms 702, 704, 706, 708, and 710. The flat spring 700 has an inner ring 712 and outer circumferential boundary 714. The inner connection points 716, 718, 720, 722, and 724 are located approximately every 72 degrees along the inner ring 712. The outer connection points 726, 728, 730, 732, and 734 are located approximately every 72 degrees along the outer circumferential boundary 714.

FIG. 8 shows an oval flat spring 800 with four arms 802, 804, 806, and 808. The flat spring 800 has an inner ring 810 and outer oval boundary 812. The inner connection points 814, 816, 818, and 820 are located approximately every 90 degrees along the inner ring 810. The outer connection points 822, 824, 826, and 828 are located at approximately regular intervals around the outer oval boundary 812.

FIG. 9 shows an octagonal flat spring 900 with four spiral-shaped arms 902, 904, 906, and 908. The flat spring 900 has an inner ring 910 and outer octagonal boundary 912. The inner connection points 914, 916, 918, and 920 are located approximately every 90 degrees along the inner ring 910. The outer connection points 922, 924, 926, and 928 are located approximately at the center of four of the sides of the outer octagonal boundary 912.

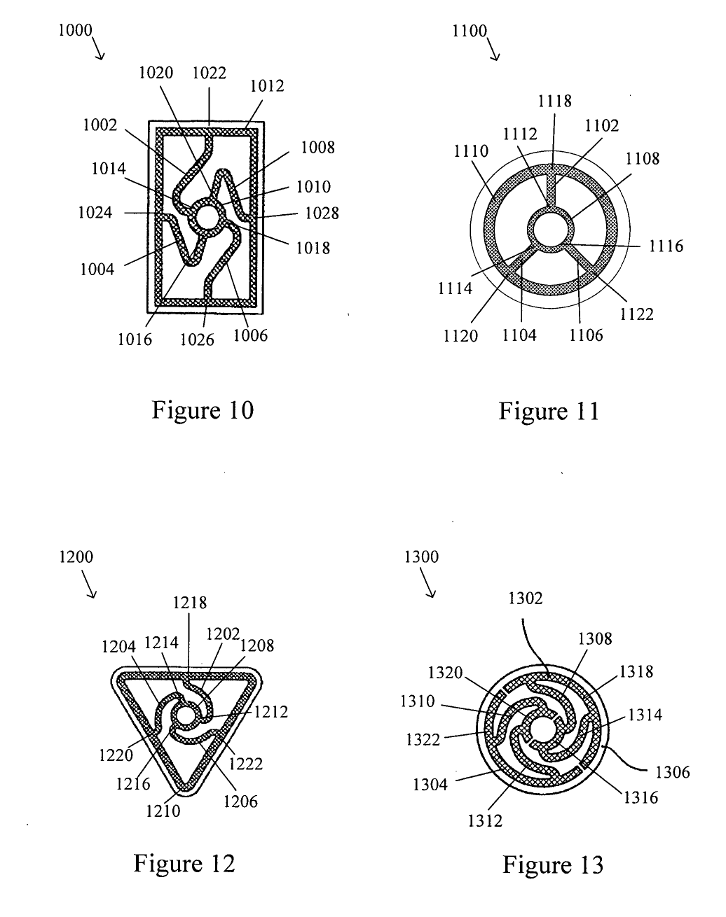

FIG. 10 shows a rectangular flat spring 1000 with four arms 1002, 1004, 1006, and 1008. The flat spring 1000 has an inner ring 1010 and outer rectangular boundary 1012. The inner connection points 1014, 1016, 1018, and 1020 are located at approximately every 90 degrees along the inner ring 1010. The outer connection points 1022, 1024, 1026, and 1028 are located approximately at the center of each side of the outer rectangular boundary 1012.

FIG. 11 shows a circular flat spring 1100 with three straight arms 1102, 1104, and 1106. The flat spring 1100 has an inner ring 1108 and outer circumferential boundary 1110. The inner connection points 1112, 1114, and 1116 are located approximately every 120 degrees along the inner ring 1108. The outer connection points 1118, 1120, and 1122 are located approximately every 120 degrees along the outer circumferential boundary 1110.

FIG. 12 shows a triangular flat spring 1200 with three spiral-shaped arms 1202, 1204, and 1206. The flat spring 1200 has an inner ring 1208 and outer triangular boundary 1210. The inner connection points 1212, 1214, and 1216 are located approximately every 120 degrees along the inner ring 1208. The outer connection points 1218, 1220, and 1222 are located approximately at the center of each side of the outer triangular boundary 1210.

FIG. 13 shows a circular flat spring 1300 including two separate electrically conductive parts 1302 and 1304. In this configuration, the parts 1302 and 1304 are electrically isolated from one another. The parts 1302 and 1304 may electrically connect the audio input signal to the electroacoustic converter. For example, the audio signal may be connected to part 1302 while ground may be connected to part 1304. Additional corresponding connections may extend to the electroacoustic converter. The flat spring 1300 may sit inside the earpiece attachment structure 1306. In FIG. 13, the flat spring 1300 includes four spiral-shaped arms 1308, 1310, 1312, and 1314. Part 1302 includes two arms 1308 and 1314 that extend radially from the inner portion 1316 of part 1302 to the outer portion 1318 of part 1302. Part 1304 includes two arms 1310 and 1312 that extend radially from the inner portion 1320 of part 1304 to the outer portion 1322 of part 1304.

In this configuration, the flat spring 1300 may be manufactured from an electrically conductive material such as resilient flexprint, resilient steel, or other elastic and conductive materials. Using an electrically conductive flat spring 1300 may beneficially reduce or eliminate cabling to the electroacoustic converter, may reduce the number of assembly steps, and may reduce the chance of mechanical failure.

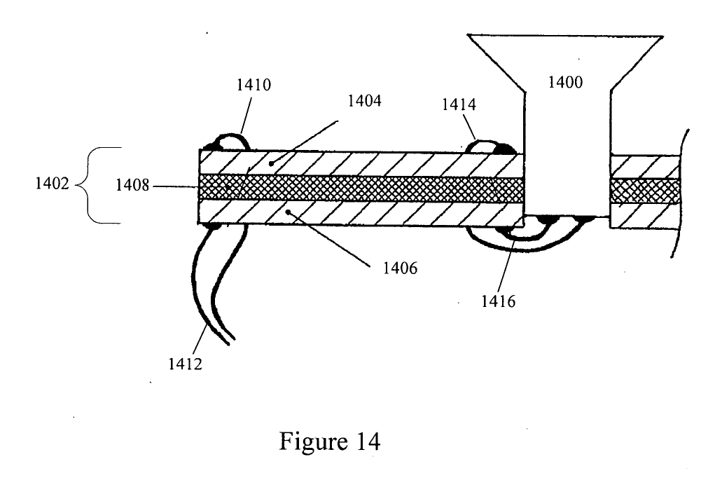

FIG. 14 shows a cross section of an electroacoustic converter 1400 and a multiple layer flat spring 1402. The flat spring 1402 includes three layers: a first electrically conductive flat spring layer 1404, a second electrically conductive flat spring layer 1406, and an insulating layer 1408. The two electrically conductive flat spring layers 1404 and 1406 may be arranged to sandwich the insulating layer 1408. The three layers 1404, 1406, and 1408 may be positioned substantially parallel to one another. The electrically conductive flat spring layers 1404 and 1406 may be manufactured from resilient flexprint, resilient steel, or other elastic and conductive materials. The insulating layer 1408 may be configured to have elastic properties similar to the electrically conductive flat spring layers 1404 and 1406. The insulating layer 1408 may be manufactured from polyurethane foam, rubber, silicone, or other elastic insulating materials. As a result, the three layers together may act together to create a constant and uniform pressure on the converter 1400 and an attached earpiece.

The two electrically conductive flat spring layers 1404 and 1406 may electrically connect the audio input signal to the electroacoustic converter 1400. For example, the audio signal may be connected to layer 1404 and ground may be connected to layer 1406. In FIG. 14, an audio signal wire 1410 (e.g., a left or right channel signal wire) and a ground wire 1412 are shown connected from the audio source to layers 1404 and 1406, respectively. An audio signal wire 1414 and a ground wire 1416 connect from layers 1404 and 1406, respectively, to the converter 1400. Other wiring configurations between the audio source, flat spring layers, and converter may be implemented instead of wires as shown in FIG. 14. Instead of audio signals, the flat spring may carry microphone signals, noise cancellation signals, data signals, or other signals.

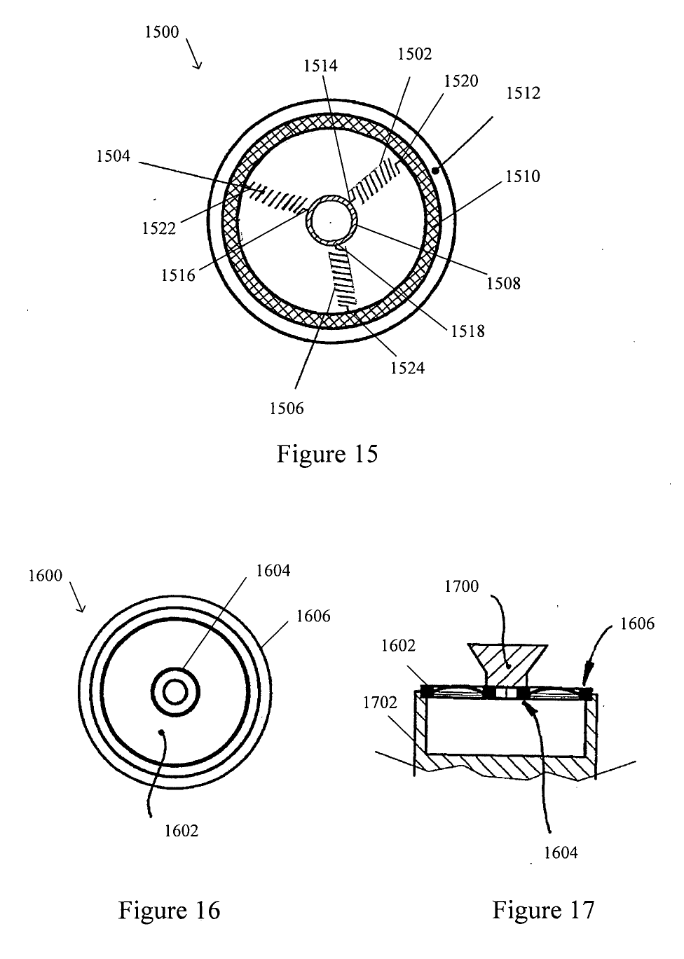

FIG. 15 shows an alternative flat spring 1500. The arms of the flat spring 1500 are the three tension springs 1502, 1504, and 1506. The flat spring may include an inner ring 1508 and outer circumferential boundary 1510, but need not be circular. The tension springs 1502, 1504, and 1506 may be tightly clamped rubber bands, threaded springs, or may have other constructions. The flat spring 1500 may sit inside the earpiece attachment structure 1512. The three tension springs 1502, 1504, and 1506 may be attached to the inner ring 1508 at inner connection points 1514, 1516, and 1518 at regular intervals. The tension springs 1502, 1504, and 1506 may be attached to the outer circumferential boundary 1510 at outer connection points 1520, 1522, and 1524 at regular intervals. The angle between each of the tension springs 1502, 1504, and 1506 may be approximately 120° or another angle. In FIG. 8, at 120°, the tension springs 1502, 1504, and 1506 produce a well-distributed pressure on the earpiece against the ear.

FIG. 16 shows an alternative flat spring 1600 formed as an elastic membrane layer 1602. The elastic membrane layer 1602 may be manufactured from rubber or some other material capable of forming a thin elastic layer. A center zone 1604 may be defined in the membrane to provide an attachment point for an electroacoustic converter. As examples, the center zone 1604 may be relatively flat, stiff, and/or appropriately dimensioned to provide a mechanically sound connection point for the converter. The membrane layer 1602 may also include a boundary 1606, such as a circumferential boundary when the membrane 1602 is circular.

FIG. 17 shows a cross section of an electroacoustic converter 1700, elastic membrane layer 1602, and earpiece attachment structure 1702. The converter 1700 may be attached to the center zone 1604 of the elastic membrane layer 1602. The membrane boundary 1606 may attach to the outer circumferential area of the earpiece attachment structure 1702 in a two-dimensional connection. In this configuration, the membrane layer 1602 may produce a constant and uniform pressure on the converter 1700 and attached earpiece to create a seal against the listener's ear.

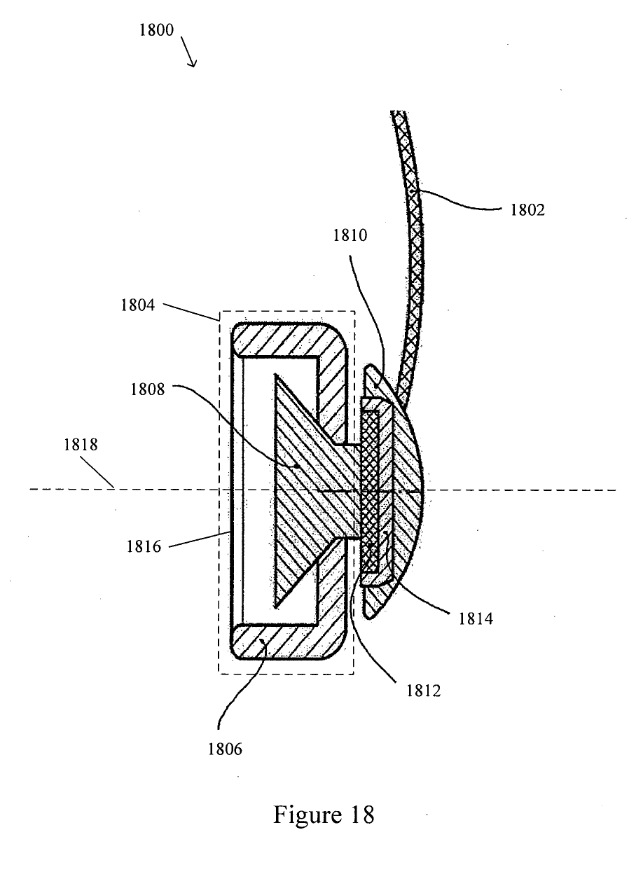

FIG. 18 shows a portion of an alternative headphones 1800, focusing on one end of the headband 1802. In this configuration, the earpiece unit 1804 may include an earpiece 1806 and an electroacoustic converter 1808. A plate 1812 and resilient pad 1814 may sit inside the earpiece attachment structure 1810. In FIG. 18, the earpiece attachment structure 1810 is dish-shaped, but other shapes and sizes may be implemented. The converter 1808 may be attached to the plate 1812, which may be manufactured of a rigid material to give the converter 1808 a firm attachment point. The plate 1812 may be attached to the resilient pad 1814, which may be made from foam or other adaptable and/or elastic material.

The plate 1812, resilient pad 1814, and earpiece 1806 may be positioned substantially parallel to one another. The resilient pad 1814 may apply a constant and uniform pressure on the converter 1808 and attached earpiece 1806. The pressure may be exerted on an axis 1818 perpendicular to and away from the plate 1812 and resilient pad 1814. The inner surface 1816 of the earpiece 1806 may rest on or around the listener's ear. The inner surface 1816 thus applies a constant and uniform pressure on the listener's ear, creating a seal from the outside environment.

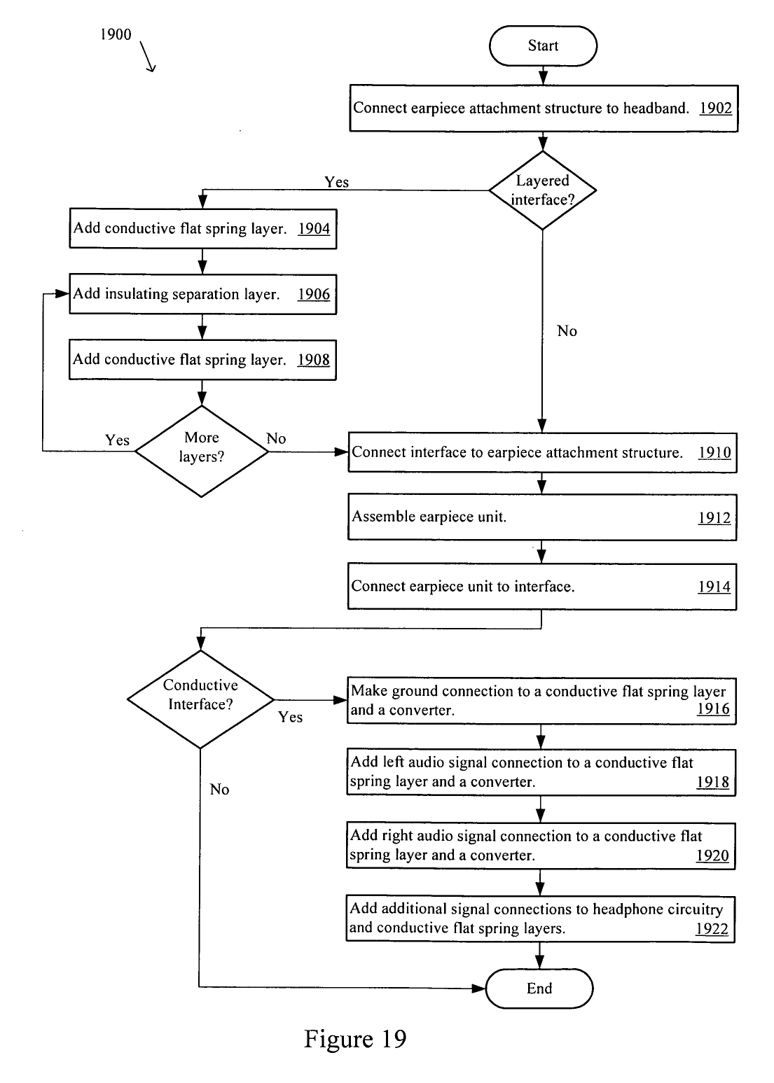

FIG. 19 shows a process 1900 for manufacturing headphones with an elastic interface between the headband and earpieces. The earpiece attachment structure may first be connected to the headband (Act 1902). The earpiece attachment structure may be dish-shaped or may be other shapes and sizes. When the headphones will include a multiple layer interface, the manufacturing process may build the interface by establishing a first layer (Act 1904), adding an insulating layer (Act 1906), and adding a second layer (Act 1908). The process may add additional layers. The layered elastic interface may include multiple electrically conducting flat spring layers sandwiching one or more insulating layers.

The process connects the interface to the earpiece attachment structure (Act 1910) and assembles the earpiece unit (Act 1912). The earpiece unit may include the electroacoustic converter, earpiece, and/or other structures and circuitry. The process also connects the earpiece unit to the interface (Act 1914). As examples, the process may connect the electroacoustic converter or the earpiece to the interface. When the interface is an electrically conductive interface, the process may form electrical connections to the interface. As examples, the process may make a ground connection to a conductive flat spring layer and a converter (Act 1916), add a left audio signal connection to a conductive flat spring layer and a converter (Act 1918), add a right audio signal connection to a conductive flat spring layer and a converter (Act 1920), and add additional signal connections to the headphone circuitry and conductive flat spring layers (Act 1922). The additional signal connections may include microphone signal connections, noise filtering circuitry connections, or other electrical connections. Other wiring configurations may be used to connect the audio source and the electroacoustic converter.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. Headphones, comprising:
an earpiece unit retention structure; and
an earpiece unit comprising:
an earpiece; and
an electroacoustic converter; and
a flat spring connecting the earpiece unit to the earpiece unit retention structure, the flat spring comprising:
an inner connector;
an outer boundary; and
multiple arms extending outward from the inner connector to the outer boundary, where the flat spring provides an approximately uniform pressure along an axis perpendicular to the flat spring.

2. The headphones of claim 1, where:
the electroacoustic converter is connected to the flat spring.

3. The headphones of claim 1, where:
the earpiece is connected to the flat spring.

4. The headphones of claim 1, where:
the arms extend in a non-linear pattern from the inner connector to the outer boundary.

5. The headphones of claim 1, where:
the multiple arms comprise outer connection points positioned at apexes of an equilateral polygon.

6. The headphones of claim 1, further comprising:
an earpiece attachment structure connected to the earpiece unit retention structure and to the earpiece unit through the flat spring.

7. Headphones, comprising:
an earpiece unit retention structure; and
an earpiece unit comprising:
an earpiece; and
an electroacoustic converter; and
a flat spring connecting the earpiece unit to the earpiece unit retention structure, the flat spring comprising:
multiple flat spring layers; and
a separating layer disposed between the multiple flat spring layers.

8. The headphones of claim 7, where the multiple flat spring layers comprise conductive flat spring layers, and where the separating layer comprises an insulating layer.

9. The headphones of claim 8, where the conductive flat spring layers comprise:
a ground layer; and
an audio signal layer.

10. The headphones of claim 8, where the conductive flat spring layers comprise:
a microphone signal layer.

11. The headphones of claim 7, where the flat spring further comprises:
an inner connector;
an outer boundary; and
multiple arms extending outward from the inner connector to the outer boundary.

12. The headphones of claim 11, where:
the arms extend in a non-linear pattern from the inner connector to the outer boundary.

13. The headphones of claim 7, further comprising:
an earpiece attachment structure connected to the earpiece unit retention structure and to the earpiece unit through the flat spring.

14. The headphones of claim 13, where the earpiece attachment structure defines a recess in which the flat spring sits.

15. A headphone manufacturing method comprising:
obtaining an earpiece unit retention structure;
connecting a multiple arm flat spring to the earpiece unit retention structure;
obtaining an earpiece unit;
attaching the earpiece unit to the flat spring.

16. The headphone manufacturing method of claim 15, further comprising:
forming an electrical connection to the multiple arm flat spring.

17. The headphone manufacturing method of claim 16, where forming comprises:
forming a ground connection to the multiple arm flat spring; and
forming an audio signal connection to the multiple arm flat spring.

18. The headphone manufacturing method of claim 16, where forming comprises:
forming a microphone signal connection to the multiple arm flat spring.

19. The headphone manufacturing method of claim 15, where connecting comprises:
connecting a multiple arm flat spring comprising outer connection points positioned at apexes of an equilateral polygon to the earpiece unit retention structure.

20. The headphone manufacturing method of claim 15, further comprising:
providing an earpiece attachment structure that defines a recess in which the flat spring sits, the earpiece attachment structure connected to the earpiece unit retention structure and to the earpiece unit through the flat spring.
